(19) United States
(12) Patent Application Publication
(10) Pub. No.: US 2026/0036428 A1
(43) Pub. Date: Feb. 5, 2026

(54) INTELLIGENT NAVIGATIONAL ROUTING

(71) Applicant: T-MOBILE INNOVATIONS LLC, Overland Park, KS (US)

(72) Inventor: Kade Lee SCOTT, McKinney, TX (US)

(21) Appl. No.: 18/791,077

(22) Filed: Jul. 31, 2024

(51) Int. Cl. G01C 21/34; B60W 60/00; G06Q 30/0601

(52) U.S. Cl. CPC G01C 21/3415; G06Q 30/0639; B60W 60/0025

(57) ABSTRACT

Systems and methods are provided for intelligent navigational routing to items utilizing network nodes and a plurality of sensor data. A telecommunications network can manage and track any nodes on the network including user equipment (UEs), base stations, and any other devices connected to the network (e.g., computers, laptops, tablets, store logistics systems, etc.). The present disclosure utilizes information from the network and external sources (e.g., store inventory) to track items in order to provide real-time navigational routing to locations (e.g., brick and mortar locations/stores) for item pickup/retrieval. The system can provide prompts to a user to remind them of an item to retrieve and can further communicate instructions for retrieval to autonomous systems (e.g., autonomous vehicles) such that the items can be retrieved without manual retrieval by a user.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for intelligent navigational routing. More particularly, in aspects set forth herein, systems and methods enable integration of network components with external sensor systems to identify locations of items of interest for users. The network can identify the location using item tracking information from the sensor systems and provide a navigational route for pick up of the item. The navigational route can be created for an autonomous system such that pick up of the item is automated and controlled by the manager 106.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a diagram of an exemplary navigational pathing/routing in which implementations of the present disclosure may be employed, in accordance with aspects herein;

FIG. 3 depicts a flow diagram of a method for intelligent routing, in accordance with aspects herein;

FIG. 4 depicts a flow diagram of a method for intelligent routing, in accordance with aspects herein; and

FIG. 5 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
APN Access Point Name
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCS Personal Communications Service
PDA Personal Digital Assistant
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UDR Unified Data Repository
UE User Equipment

Further, various technical terms are used throughout this description. An illustrative resource that fleshes out various aspects of these terms can be found in Newton's Telecom Dictionary, 32d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

In conventional cellular communications technology, a 5G telecommunications network comprises a 5G Core Network (5GC) and a gNB. The 5GC architecture, as known to those in the art, relies on a Service-Based Architecture (SBA) framework where the architecture elements are defined in terms of Network Functions (NF) rather than by traditional network entities. Using interfaces of a common framework, any NF can offer its services to other NFs that are permitted to make use of their functions. At times, the network interfaces can experience complete failures, degradations, and the like. This compromises the ability of other NFs to obtain necessary data to establish reliable sessions for UEs.

The present disclosure is directed to intelligent routing. A telecommunications network can manage and track any nodes on the network including user equipment (UEs), base stations, and any other devices connected to the network (e.g., computers, laptops, tablets, store logistics systems, etc.). The present disclosure utilizes information from the network and external sources (e.g., store inventory) to track items in order to provide real-time navigational routing to locations (e.g., brick and mortar locations/stores) for item pickup/retrieval. The system can provide prompts to a user to remind them of an item to retrieve and can further communicate instructions for retrieval to autonomous systems (e.g., autonomous vehicles) such that the items can be retrieved without manual retrieval by a user.

Accordingly, a first aspect of the present disclosure is directed to a system for intelligent routing. The system comprises one or more processors; and one or more computer-readable media storing computer-usable instructions that, when executed by the one or more processors, cause the one or more processors to: receive an indication of a trigger event; ping a plurality of network nodes to identify a location of an item associated with the trigger event; and provide a navigational route to the item.

A second aspect of the present disclosure is directed to a method for intelligent routing. The method comprises receiving an indication of a trigger event; pinging a plurality of network nodes to identify a location of an item associated with the trigger event; providing a prompt to retrieve the item at predetermined time intervals; and providing a navigational route to the item.

Another aspect of the present disclosure is directed to a system for intelligent routing. The system comprises one or more processors; and one or more computer-readable media storing computer-usable instructions that, when executed by the one or more processors, cause the one or more processors to: receive an indication of a trigger event; ping a plurality of network nodes to identify a location of an item associated with the trigger event; determine that a user equipment (UE) associated with the trigger event is located within a vehicle; deliver a prompt to retrieve the item associated with the trigger event; and communicate a route to retrieve the item.

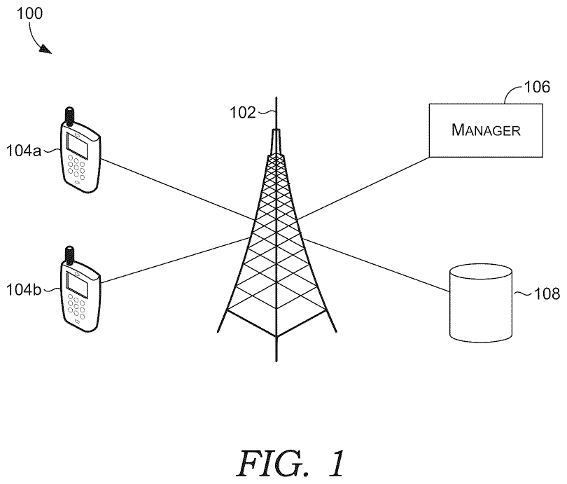

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

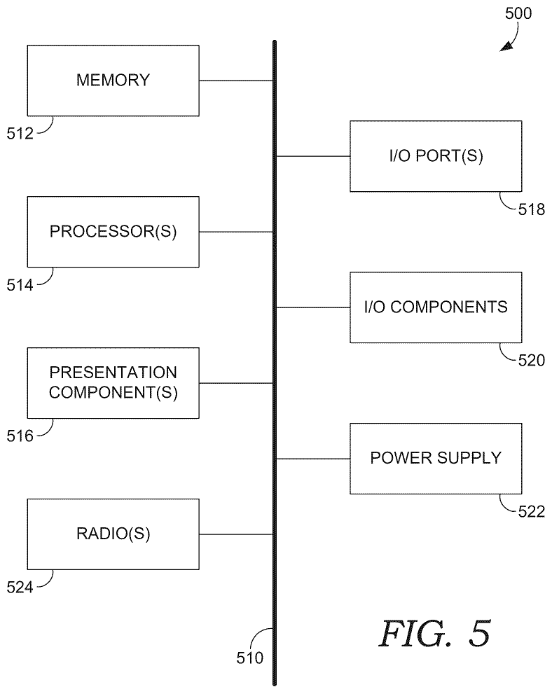

A network cell may comprise a base station 102 to facilitate wireless communication between a communications device within the network cell, such as communications device 500 described with respect to FIG. 5, and a network. As shown in FIG. 1, communications device may be UE 104a, UE 104b, among others not shown. For simplicity, reference to UE 104a and UE 104b will be in the singular nature but is understood to be a single UE or a plurality of UEs. In the network environment 100, UE 104a may communicate with other devices, such as mobile devices, servers, etc. The UE 104a may take on a variety of forms, such as a personal computer, a laptop computer, a tablet, a netbook, a mobile phone, a Smart phone, a personal digital assistant, or any other device capable of communicating with other devices. For example, the UE 104a may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 104a comprises a wireless or mobile device with which a wireless telecommunication network(s) can be utilized for communication (e.g., voice and/or data communication). In this regard, the UE 104a can be any mobile computing device that communicates by way of, for example, a 5G network.

The UE 104a may utilize a network to communicate with other computing devices (e.g., mobile device(s), a server(s), a personal computer(s), etc.). In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, the network is associated with a telecommunications provider that provides services to user devices, such as UE 104a. For example, the network may provide voice services to user devices or corresponding users that are registered or subscribed to utilize the services provided by a telecommunications provider.

The network can include one or more base stations, such as base station 102. The base station 102 can communicate with any number of UEs within its designated coverage area. The base station 102 can also communicate with manager 106. The manager 106 can be a part of the network or a distributed computing device. The manager 106 and base station 102 are also in communication with one or more sensors or sensor arrays (not shown). The one or more sensors or sensor arrays can be a variety of sensors known in the art today such as, but not limited to, acoustic sensors, camera sensors, pressure sensors, logistics sensors (e.g. item tracking), and the like. The sensor(s)/sensor array can be used to detect trigger events. A trigger event, as used herein, refers generally to an event that indicates obtaining an item is initiated or desirable for the user. For instance, obtaining of an item is initiated when an item is purchased, via an online session. Obtaining an item may be indicated as desirable when the item is, for instance, added to a user's shopping cart or is viewed at a rate that satisfies a predetermined viewing threshold (e.g., a user views the item a predetermined number of times in a predetermined period of time). The sensor(s)/sensor array can also be used to facilitate retrieval of items by communication across a network to other systems such as, for instance, a retailer logistics system. In an example, an item retrieval may be initiated such that an autonomous system (e.g., autonomous vehicle, unmanned aerial vehicle (drone), etc.) is sent to obtain the item and the logistics system can monitor their input to identify when the autonomous vehicle arrives (e.g., camera in parking spot, parking spot sensors, etc.).

The intelligent routing can be activated by way of a trigger event (purchase of an item, interest in an item as defined by predetermined viewing thresholds, etc.). Once activated, the sensors of the network and other systems can initiate a network notification process. The network (i.e., base station 102) can communicate with the manager 106 to facilitate communication with sensor systems to identify a location of the item that has been indicated. Again, the item may have been purchased and require retrieval or may be of interest such that the network maintains a record of the item and can prompt a user to revisit the item online or obtain the item. Even if the item has not yet been purchased, a location of the item may be obtained from the sensor systems in order to provide the location to the user in a future prompt to view the item.

In the event the item is purchased, the manager 106 can identify the trigger event executed by, for instance, UE 104a. Upon identifying the trigger event (e.g., purchase) the manager 106 determines that the item is to be picked up (e.g., based on the purchase confirmation). The manager 106 can evaluate sensor data from one or more external systems (e.g., retail stores) to identify a location of the item associated with the trigger event. This could be done using any known sensor systems used to track items/inventory and integration of said sensor system with the network/manager 106. For example, the manager 106 can communicate with the sensor system (network nodes) to evaluate their inventory to identify a location of the item associated with the trigger event.

Once a location is determined, the manager 106 can communicate instructions to autonomous systems to automatically retrieve the item without user interaction or input. For instance, the manager 106 could communicate instructions to retrieve the item to an autonomous vehicle, an unmanned aerial vehicle (drone), and the like, such that the autonomous system automatically initiates retrieval of the item using a route created and communicated by the manager 106 that includes a start point of either the user or an autonomous vehicle system associated with the user to an endpoint/destination where the item is located. The manager 106 can directly communicate with a control system of an autonomous system such that one or more operations of the autonomous system are controlled by the manager 106 via the navigational route communicated from the manager 106 to the autonomous system.

Some aspects herein include a user verification prompt where a user can confirm that the autonomous system should retrieve the item. Other aspects include a scheduling prompt where the user can schedule a specific time to retrieve the item and the schedule can be communicated by the manager 106 to the sensor system. In any event, whether the retrieval is immediate or scheduled at a later date/time, the manager 106 is configured to notify the sensor system associated with the item (e.g., a store retailer having the item in stock) that item retrieval has been initiated at a predetermined time.

The manager 106 can communicate various information to the sensor systems such as when the item will be picked up, the mode of pick-up (e.g., customer to pick up in the store, employee to deliver item to a predetermined pick-up spot to the customer, etc.). The manager 106 can dynamically update the information communicated. For instance, as a user or autonomous system approaches the entity associated with the sensor system for the item, the manager 106 can update an arrival time for pick up. Further, the manager 106 can communicate with the sensor system to indicate that a pick up entity has arrived. The manager 106 can also integrate with the autonomous system via cameras or other systems to identify a location of the autonomous system and communicate that location to the sensor system such that delivery of the item is confirmed to a specific location.

The above described an example where an item is purchased. Aspects herein also include where the item is an item of interest. An item of interest, as used herein, is an item that is viewed a predetermined number of times within a predetermined time period or an item that has been added to an online cart but not yet purchased. In this aspect, the manager 106 can communicate a prompt to a UE that a specific period of time has elapsed and a reminder to view the item again or a suggestion to purchase and pick up the item.

The manager 106 can determine when a UE is in a vehicle. This can be determined by identifying that a UE is traveling above a predetermined speed (e.g., 15 miles per hour). If the UE is traveling in a vehicle, the manager 106 can communicate a prompt to the UE that the item of interest is in stock at a location, along with a purchase indicator that would allow the user to immediately purchase the item for pickup at the designated location having the item in stock. The manager 106 can integrate with a navigation system either of a vehicle or an application of the UE to identify a predetermined route of a user in order to evaluate locations along the route to identify a location along the route having the item of interest in stock. In the event the manager 106 is controlling an autonomous system, the manager 106 can modify a predetermined route of the user to include the location of the item as a waypoint (i.e., a stop along the way to the original destination).

While evaluating the locations, the manager 106 can be configured to filter locations to only those along the predetermined route, within a predetermined distance from the original destination, fewest distance from the UE, fewest turns, etc. The manager 106 can ignore any entity that is determined to not have the item in stock when providing pick up options to the UE. In aspects, the manager 106 identifies a closest entity having the item available and automatically routes the autonomous system to the closest entity.

As with the previous example, once the item is purchased, the manager 106 can communicate with external sensor systems to indicate a pick up is initiated, a user and/or autonomous system is en route to pick up an item, a mode of delivery (in store pick up, employee brings the item out to the user, etc.), estimated arrival time, and the like. Sensor systems may use a variety of sensors including, but not limited to, sonar, video, LIDAR, etc. For instance, a sensor system can use a video system to detect a vehicle is in a parking spot for item pick up. The manager 106 can further aid in sensor systems monitoring by providing updates such as a user location for pick up. For instance, a user may be determined to be in a geo-fenced area associated with the entity for pick up, but not within a designated pick up area. In that case, no notification is provided to the entity for pick up. However, once the manager 106 or the sensor system determine that the user and/or autonomous system identified by the manager 106 is in the pick up location (e.g., predetermined parking spot, predetermined pick up location within a geo-fenced area, etc.) then a notification can be communicated from the manager 106 of the network to the sensor system. Once the notification is communicated from the manager 106 to the sensor system, the sensor system sensors can validate the information (e.g., the manager 106 indicates the autonomous vehicle is in parking spot 11, the sensor system's camera can validate the autonomous vehicle is in parking spot 11).

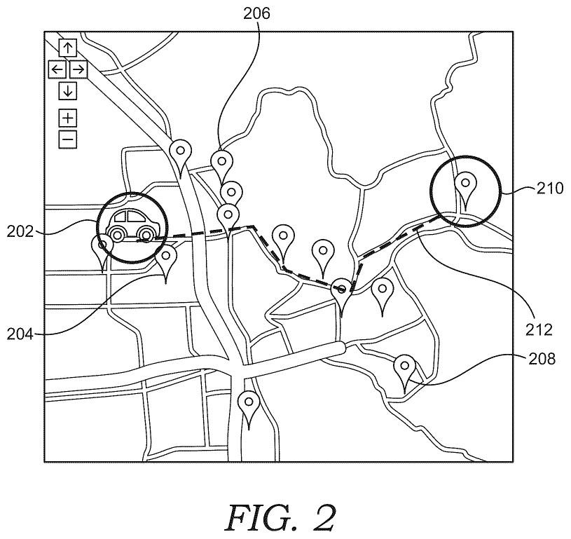

Turning to FIG. 2, an exemplary display of a manager 106 providing navigation to an in-stock item is provided. The autonomous system, shown in FIG. 2 as a vehicle 202, can be automatically routed to an item location. As shown in FIG. 2, locations 204, 206, and 208 are provided. These locations are highlighted as all having an item of interest in-stock and available for pick up along the route to the original destination 210 along predetermined route 212. In aspects, manager 106 may modify route 212 to include a stop at location 204 as it is closest to the vehicle 202. Alternatively, the manager 106 can modify route 212 to include a stop at location 208 as it is closer to the original destination 210. Location 206 may be included in the route as it is along a highway and may be more convenient, based on user route preferences.

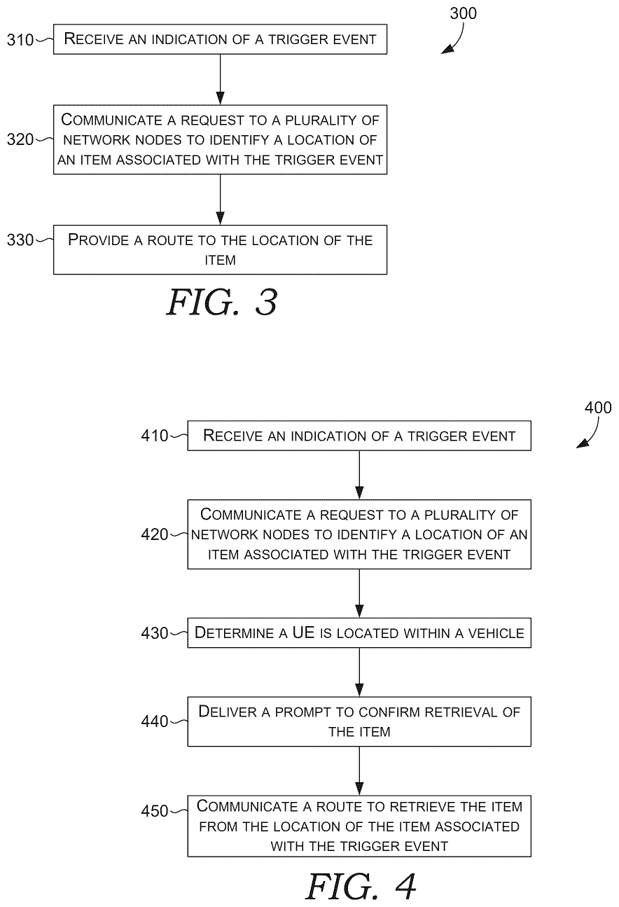

Turning to FIG. 3, a flow diagram 300 is provided illustrating a flow for intelligent routing. At block 310, an indication of a trigger event is received. As described, a trigger event can be a purchase of an item. At block 320, a request is communicated to a plurality of network nodes to identify a location of an item associated with the trigger event. A navigational route to the location of the item associated with the trigger event is provided at block 330.

Referring to FIG. 4, a flow diagram 400 is provided illustrating a flow for intelligent routing. At block 410, an indication of a trigger event is received. A request is communicated to a plurality of network nodes to identify a location of an item associated with the trigger event at block 420. At block 430, it is determined that a user equipment (UE) associated with the trigger event is located within a vehicle. This determination can be made based on a speed at which the UE is moving. At block 440, a prompt is delivered to retrieve the item associated with the trigger event. At block 450, a route to retrieve the item from the location of the item associated with the trigger event is communicated.

Referring to FIG. 5, a block diagram of an exemplary computing device 500 suitable for use in implementations of the technology described herein is provided. In particular, the exemplary computer environment is shown and designated generally as computing device 500. Computing device 500 is but one example of a suitable computing environment and is not intended to suggest any limitation as to the scope of use or functionality of the invention. Neither should computing device 500 be interpreted as having any dependency or requirement relating to any one or combination of components illustrated. It should be noted that although some components in FIG. 5 are shown in the singular, they may be plural. For example, the computing device 500 might include multiple processors or multiple radios. In aspects, the computing device 500 may be a UE/WCD, or other user device, capable of two-way wireless communications with an access point. Some non-limiting examples of the computing device 500 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 5, computing device 500 includes a bus 510 that directly or indirectly couples various components together, including memory 512, processor(s) 514, presentation component(s) 516 (if applicable), radio(s) 524, input/output (I/O) port(s) 518, input/output (I/O) component(s) 520, and power supply(s) 522. Although the components of FIG. 5 are shown with lines for the sake of clarity, in reality, delineating various components is not so clear, and metaphorically, the lines would more accurately be grey and fuzzy. For example, one may consider a presentation component such as a display device to be one of I/O components 520. Also, processors, such as one or more processors 514, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 512 may take the form of memory components described herein. Thus, further elaboration will not be provided here, but it should be noted that memory 512 may include any type of tangible medium that is capable of storing information, such as a database. A database may be any collection of records, data, and/or information. In one embodiment, memory 512 may include a set of embodied computer-executable instructions that, when executed, facilitate various functions or elements disclosed herein. These embodied instructions will variously be referred to as “instructions” or an “application” for short.

Processor 514 may actually be multiple processors that receive instructions and process them accordingly. Presentation component 516 may include a display, a speaker, and/or other components that may present information (e.g., a display, a screen, a lamp (LED), a graphical user interface (GUI), and/or even lighted keyboards) through visual, auditory, and/or other tactile cues.

Radio 524 represents a radio that facilitates communication with a wireless telecommunications network. Illustrative wireless telecommunications technologies include CDMA, GPRS, TDMA, GSM, and the like. Radio 524 might additionally or alternatively facilitate other types of wireless communications including Wi-Fi, WiMAX, LTE, 3G, 4G, LTE, mMIMO/5G, NR, VOLTE, or other VoIP communications. As can be appreciated, in various embodiments, radio 524 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 518 may take a variety of forms. Exemplary I/O ports may include a USB jack, a stereo jack, an infrared port, a firewire port, other proprietary communications ports, and the like. Input/output (I/O) components 520 may comprise keyboards, microphones, speakers, touchscreens, and/or any other item usable to directly or indirectly input data into the computing device 500.

Power supply 522 may include batteries, fuel cells, and/or any other component that may act as a power source to supply power to the computing device 500 or to other network components, including through one or more electrical connections or couplings. Power supply 522 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system for intelligent routing, the system comprising:
one or more processors; and
one or more computer-readable media storing computer-usable instructions that, when executed by the one or more processors, cause the one or more processors to:
receive an indication of a trigger event;
communicate a request to a plurality of network nodes to identify a location of an item associated with the trigger event; and
provide a navigational route to the location of the item associated with the trigger event.

2. The system of claim 1, wherein the trigger event is an online purchase of the item.

3. The system of claim 1, wherein the trigger event is an online action related to the item and an elapsed predetermined period of time.

4. The system of claim 1, wherein the one or more processors further provide a prompt for confirmation to navigate to the location of the item.

5. The system of claim 1, wherein the navigational route is provided to an autonomous system.

6. The system of claim 5, wherein the autonomous system is an autonomous vehicle.

7. The system of claim 1, wherein the processors further communicate a notification to a node associated with the location of the item that the item will be retrieved.

8. A method for intelligent routing, the method comprising:
receiving an indication of a trigger event;
communicating a request to a plurality of network nodes to identify a location of an item associated with the trigger event;
providing a prompt to retrieve the item associated with the trigger event at predetermined time intervals; and
providing a navigational route to the location of the item associated with the trigger event.

9. The method of claim 8, wherein the trigger event is an online purchase of the item.

10. The method of claim 8, wherein the trigger event is an online action related to the item and an elapsed predetermined period of time.

11. The method of claim 8, wherein the navigational route is provided to an autonomous system.

12. The method of claim 11, wherein the autonomous system is an autonomous vehicle.

13. The method of claim 12, further comprising providing a prompt for confirmation to navigate the autonomous vehicle to the location of the item.

14. The method of claim 8, further comprising communicating a notification to a node associated with the location of the item that the item will be retrieved.

15. A system for intelligent routing, the system comprising:
one or more processors; and
one or more computer-readable media storing computer-usable instructions that, when executed by the one or more processors, cause the one or more processors to:
receive an indication of a trigger event;
communicate a request to a plurality of network nodes to identify a location of an item associated with the trigger event;
determine that a user equipment (UE) associated with the trigger event is located within a vehicle;
deliver a prompt to retrieve the item associated with the trigger event; and
communicate a route to retrieve the item from the location of the item associated with the trigger event.

16. The system of claim 15, wherein the one or more processors further identify an existing route of the vehicle.

17. The system of claim 16, wherein the one or more processors further modify the existing route to include the location of the item.

18. The system of claim 15, wherein the one or more processors further determine that a predetermined period of time has elapsed prior to delivery of the prompt to retrieve the item.

19. The system of claim 15, wherein the location of the item is a physical location having the item in a physical state available for retrieval.

20. The system of claim 19. wherein the one or more processors further ignore any destinations that do not have the item in a physical state available for retrieval.
